(19) United States
(12) Patent Application Publication
(10) Pub. No.: US 2024/0295724 A1
(43) Pub. Date: Sep. 5, 2024

(54) CAVITY FOR INTENSITY BUILD UP OF MULTIPLE LASERS

(71) Applicant: California Institute of Technology, Pasadena, CA (US)

(72) Inventors: Yi Zeng, Pasadena, CA (US); Nicholas Hutzler, Pasadena, CA (US)

(73) Assignee: California Institute of Technology, Pasadena, CA (US)

(21) Appl. No.: 18/421,323

(22) Filed: Jan. 24, 2024

Related U.S. Application Data
(60) Provisional application No. 63/440,735, filed on Jan. 24, 2023.

(51) Int. Cl. G02B 17/00; G02B 17/06; G21B 1/23; G21K 1/00

(52) U.S. Cl. CPC G02B 17/004; G02B 17/0615; G02B 17/0684; G21B 1/23; G21K 1/00

(57) ABSTRACT

The present disclosure describes a cavity accumulating the intensity of the laser beams reflecting within the cavity to build up power while also maintaining a relatively uniform intensity distribution. An apparatus comprising the cavity can be used to build up the power of the electromagnetic radiation for interacting with material, wherein the material does not substantially reflect or absorb the electromagnetic radiation.

### CROSS-REFERENCE TO RELATED APPLICATIONS

This application claims the benefit under 35 U.S.C. Section 119(e) of commonly assigned and co-pending U.S. Provisional Application No. 63/440,735, filed Jan. 24, 2023, by Yi Zeng and Nicholas Hutzler, entitled “CAVITY FOR INTENSITY BUILDUP OF MULTIPLE LASERS,” CIT 8953-P.

### BACKGROUND OF THE INVENTION

Atoms, ions, molecules, or engineered materials have emerged as promising platforms for precision measurements [1-4], quantum simulations [5-9], and fundamental chemistry [8,10,11]. Such platforms utilize high power and narrow linewidth lasers for trapping or quantum control but the stringent requirements for linewidth (≤MHz), time-varying frequency, sidebands, power, and polarizations can be challenging to implement. As quantum control extends to even larger and more complicated molecules [4,17,18], these requirements will become even more challenging particularly with the need to address multiple transitions.

One method to ease these difficulties is to use low-power lasers and build up intensity with a power build-up cavity [19-21], where resonance is used to increase the laser power circulating in the cavity. However, this technique typically requires active stabilization and can only work with a small number of lasers due to the required resonant condition. Another method is to use a multi-pass setup wherein the laser beams reflect between two or more mirrors. Such a method is generally useful if the goal is to amplify the power in an extended interaction region (e.g., with a molecule beam [14,22]). However, the performance is limited if high intensity and uniformity are needed in a confined region. What is needed, then, are improved methods that can build up power with high intensity and uniformity, for simultaneously accommodating multiple lasers of different frequencies. The present disclosure satisfies this need.

### SUMMARY OF THE INVENTION

The present disclosure describes a cavity accumulating the intensity of the laser beams bouncing back and forth within the cavity to build up power while also maintaining a relatively uniform intensity distribution (for example, similar to that of a Gaussian beam). The cavity is useful for applications requiring high laser intensities and power where only an insignificant portion of the power is lost at the interaction region through reflection or absorption by the sample.

### BRIEF DESCRIPTION OF DRAWINGS

FIG. 1a. Schematic of a cavity according to one or more embodiments.

FIG. 1b. Perspective view of the cavity.

FIG. 1c. View of the cavity mounted in a housing and showing the beam passes through the cavity.

FIG. 1d. Close up view of the concave mirror comprising the entry hole.

FIG. 2a Pattern of spots traced out by the reflecting laser beam on the mirrors. The solid dots are spots on the near mirror (NM), which is the one with the entry hole, and the circles are spots on the far mirror (FM). Figure adapted from [24]. FIG. 2b Pattern for one of the embodiments of the present invention when the cavity is at a near-concentric configuration, and the angle θ between consecutive spots are close to 180°.

FIGS. 3a-3b. Cross sections of laser beams in a d=3.96f Herriott cell, where the spot sizes are roughly uniform; hence, the “collimated” configuration. Here, the circles indicate the size and position of the reflecting beam. The pattern is generated using a simple model based on ray transfer matrix analysis [26]. FIG. 3a Intensity distribution on the near mirror. The entry spot 0 and first three reflecting spots are labeled. FIG. 3b Intensity distribution at the middle of the cavity. Note that the size scale is 10 times smaller. The first six passes are labeled.

FIGS. 4a-4f. Example of a diverging configuration. Calculated cross section patterns of laser beam sizes and positions, contour plot of intensity distribution, and photos of the same configuration in a prototype setup. FIG. 4a Pattern on the near mirror. The entry spot 0, and first three spots are labeled. FIG. 4b Pattern at the center of the cavity (size scale is 10 times smaller). The first two passes are labeled. FIG. 4c Calculated contour plot at cavity center, with the intensity normalized against input Gaussian beam. FIG. 4d The simulated contour plot was generated using LightTools and normalized against a uniform input beam. FIG. 4e Photo of the near mirror, where the bright circle on the right side is the entry hole. FIG. 4f. Photo of scattered light on an AR-coated window placed at cavity center, with the intensity normalized against single pass.

FIG. 5a. Flowchart illustrating a method of making a cavity.

FIG. 5b. View showing positioning of windows and camera for imaging the uniform intensity distribution.

FIGS. 6a-6f. Measurement of intensity amplification and distribution. Photos of the scattered light on the AR-coated window at the center of the cavity were taken for different configurations using a CMOS camera. FIG. 6a. Configuration from a single pass of the laser beam. FIG. 6b. Contour plot of the same photo. FIG. 6c and FIG. 6d. Photos for the “collimated” configuration. FIG. 6e. Contour plot of FIG. 4f. All intensities are normalized against (a). FIG. 6f. A uniformity comparison between the center slices of FIG. 6b and FIG. 6e in the x direction, showing that for a range of about 1.2 mm the minimum intensity of the multipass is more than five times the maximum of the single pass.

FIG. 7. Plot showing how the illumination region size changes with the longitudinal distance from the middle of the cavity. The measured size is characterized by the diameter of the cross section where the laser light intensity is higher than the single-pass intensity. The calculated diameter is from Eq. (2). The three inserts show intensity distributions at the corresponding distance, with the same size scale and intensity scale, confirming the uniformity along the cavity length.

FIG. 8a. Photos of the AR-coated window placed at the center of the cavity. Camera is shooting at an angle of about 45°, so the scattered light from two sides of the window is sufficiently separated. FIG. 8b. Same as (a), but the laser used was changed from 650 to 577 nm.

FIG. 9a. Photo of single-pass light scattered off the vacuum chamber window. FIG. 9b. Photo of the “collimated” Herriott cell setup. FIG. 9c. Photo of a Herriott cell setup optimized for even intensity distribution. Note that these spots looks different in size because the vacuum window is closer to the cavity mirror than the interaction region. The actual size of the interaction region is similar between FIG. 9a and FIG. 9c, similar to the ones shown in FIG. 6.

FIG. 9d. Application system 900 showing the second concave mirror 104 comprising the entry hole positioned outside the sample chamber 902a (e.g., vacuum chamber).

FIG. 10. Integrated fluorescence of a sodium beam probed on the D1 transition, comparing results from three different configurations: single pass, “collimated” Herriott cell, and diverging configuration, similar to what is shown in FIG. 4.

FIG. 11. Plot showing how the misalignment in the launching mirror and far mirror affect the total power inside the illumination region. Significant power loss starts to occur when the launching mirror is misaligned by 0.24°, and when the far mirror is misaligned by 0.05°. Both are larger than typical drifts seen in the lab for common optic elements.

FIG. 12 is a Schematic of a planar cavity.

### DETAILED DESCRIPTION OF THE INVENTION

In the following description, reference is made to the accompanying drawings which form a part hereof, and which is shown, by way of illustration, several embodiments. It is understood that other embodiments may be utilized and structural changes may be made without departing from the scope of the present disclosure.

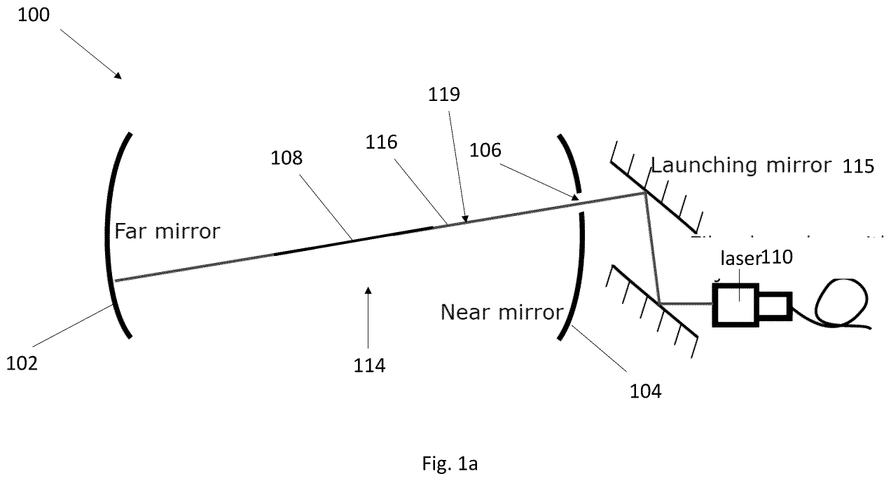

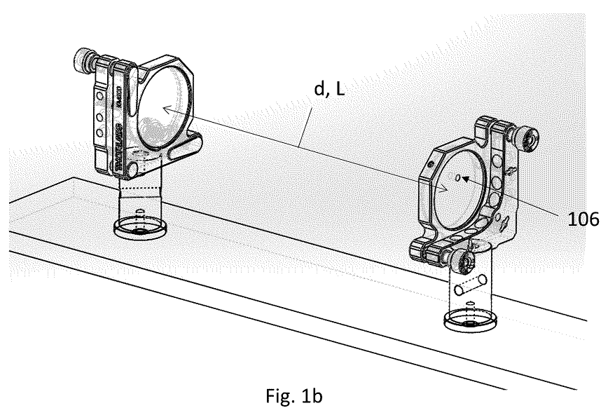

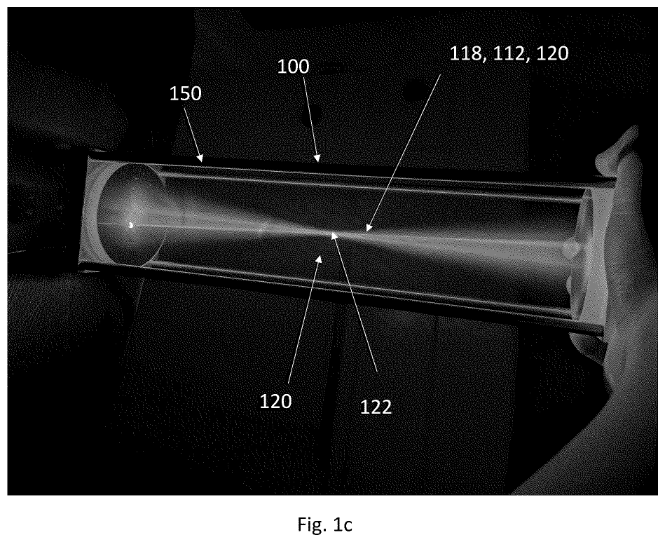

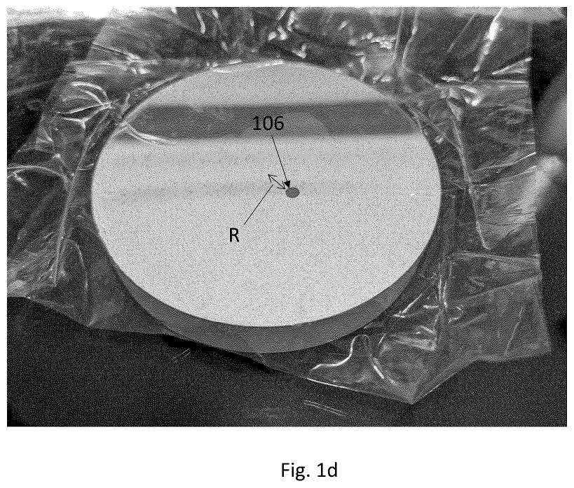

FIG. 1a, FIG. 1b, and FIG. 1c illustrate an embodiment of the cavity 100, comprising a first concave mirror 102 and a second concave mirror 104 both having the same focal length. The second concave mirror faces the first concave mirror, has an entry hole 106 for inputting a laser beam 108 into the cavity, and is separated from the first concave mirror by a distance d of slightly smaller than four times the focal length in a near concentric configuration. FIG. 1d is a close up view of the second concave mirror illustrating the entry hole.

A laser 110 is positioned to input the laser beam into the cavity through the entry hole. The laser beam is typically close to a collimated Gaussian beam, but with focus (divergence) adjusted so that all the passes of the laser beam overlap to buildup power of the electromagnetic radiation but with a more uniform intensity distribution as compared to that of the input laser beam. The radial distance R of the entry hole is selected as a trade-off between a positioning closer to the center of the mirror (to reduce leakage of the divergent beam off the mirror edges) but not so close that number of laser beam passes is reduced below an acceptable level. The position of the entry hole can be determined by simulation and/or experimentation.

In some examples, the mirrors are exactly aligned. However, some misalignments between the two mirrors can be tolerated without significant impact on the performance. When correctly configured (aligned), the laser light circulating within the cavity should typically comprise more than ˜10 passes, with more than 100 passes (corresponding to a power build of more than 100 times the input power, i.e., proportional to the number of passes) achievable when the alignment of the cavity is optimized. The power buildup is not amplification but rather comprises an cumulative addition of all the reflected laser beams overlapping within the cavity to form a uniform intensity distribution in the cavity.

FIG. 1c illustrates and example housing 150 for the cavity.

### Example Model and Simulation

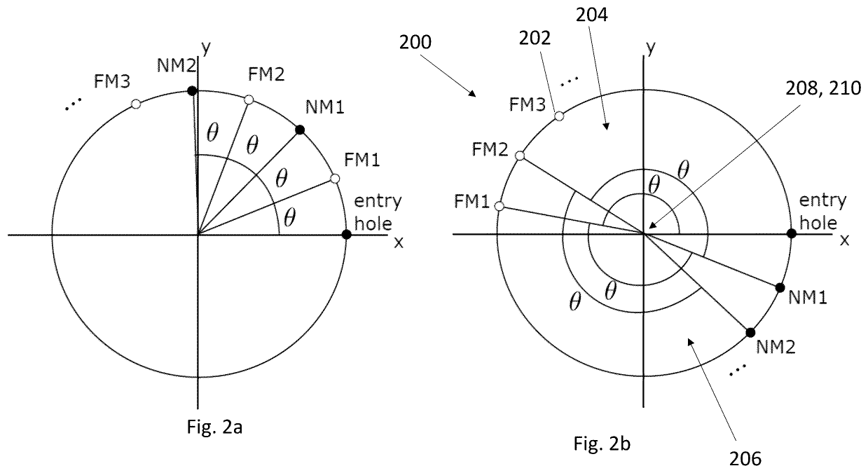

A model can be used to determine where the entry hole should be positioned on the near mirror. The simulation comprises the following steps.
1. Determining where the laser beam lands on both the near and far mirrors for each pass using the following equation:

$$cos ( θ ) = 1 - \frac{d}{2 f} ,$$

where d is the cavity length, f is the focal length of the mirrors, and θ is the angle between two spots on the mirrors projected onto the same plane, as illustrated in FIG. 2.
2 Using the positions on each mirror and geometrical considerations, calculating the beam positions between the two mirrors.
3. Using ray transfer matrix analysis to track the beam diameter of the Gaussian laser beam, which changes due to both free-space propagation and reflection from the curved mirror surfaces. The input laser beam diameter is represented by the input ray position and the focusing of the input laser is represented by the input ray angle.

In one or more embodiments, a starting configuration for the model is a Herriott cell in a near concentric configuration using a collimated laser beam. To achieve a more uniform intensity distribution, the input beam divergence is changed to increase the spot sizes of the reflections. However, the conventional Herriott cell mirrors used in spectroscopy have their entry hole very close to the mirror's edge. It was discovered that making the input beam more divergent results in the reflected beams leaking off the mirror edges, leading to power loss. This problem can be overcome by positioning the entry hole closer to the center of the mirror. Simple geometry calculation(s) can be used to determine how close the entry hole can be positioned to the center before limiting the number of passes the cavity can accommodate.

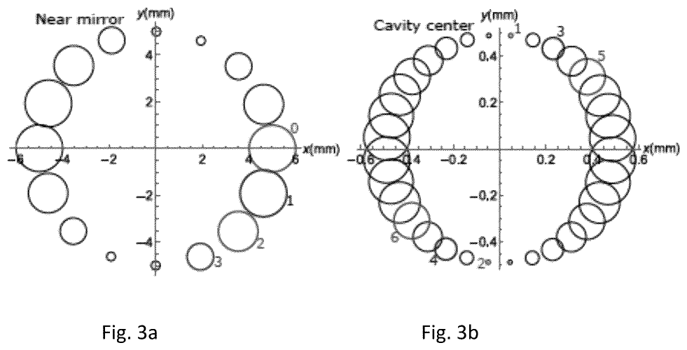

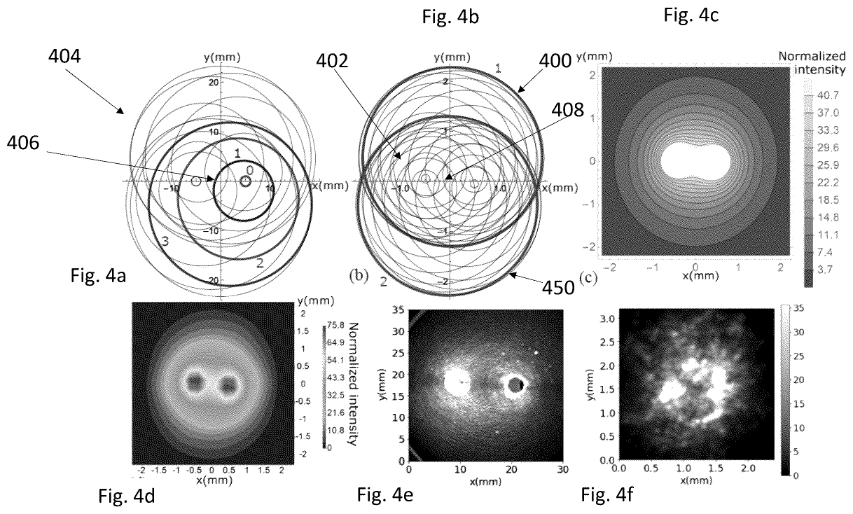

Plotting the laser beam inside the cavity using the location and size information to illustrate the cross sections of the laser beams at any position along the length of the cavity, e.g., as illustrated in FIGS. 3(a), 3(b) (for the Herriot cell in a near concentric configuration with collimated beam) and 4(a) for the divergent beam configuration. By combining the location and size data with a Gaussian power distribution, contour plots for intensity as illustrated in FIG. 4(c) can be constructed.

FIG. 4(d) illustrates the results of a ray tracing simulation (using LightTools 9.0, Synopsys, Inc.). The discrepancy between the calculated model and the simulation are due to the simulation using an input light beam of uniform intensity instead of a Gaussian beam, the calculation modeling for a reduced number of passes (in this case 32) as compared to the simulation), and the calculation not considering any leakage.

In one embodiment, the model and simulation show that the radial distance of the entry hole should be smaller than ½ of the radius of the mirror, but larger than a minimum distance required for at least 10 passes of the laser beam reflecting between the mirrors (to obtain a reasonable accumulation of power). In another embodiment, the radial distance is between ½ of the hole radius and ½ of the radius of the mirror.

The simulations and calculations highlight the significant differences between a Herriott cell and a cavity according to the present disclosure. FIG. 3 shows that in a Herriot cell configuration, the overlap is limited to a given beam pass overlapping only with the immediately preceding and immediately successive beam pass, resulting in a non-uniform intensity distribution. Moreover each beam is collimated and has a relatively small diameter. FIG. 4 shows that in a cavity according to the present invention, the overlap and size of the beams is significantly increased, resulting in a significantly more uniform intensity distribution. Specifically, FIG. 4 shows all the beam passes substantially overlap with each other such that a total power of the passes in the cavity is n times the power of the inputted laser beam, where n is the number of passes of the laser beam in the cavity.

### Example Process Steps

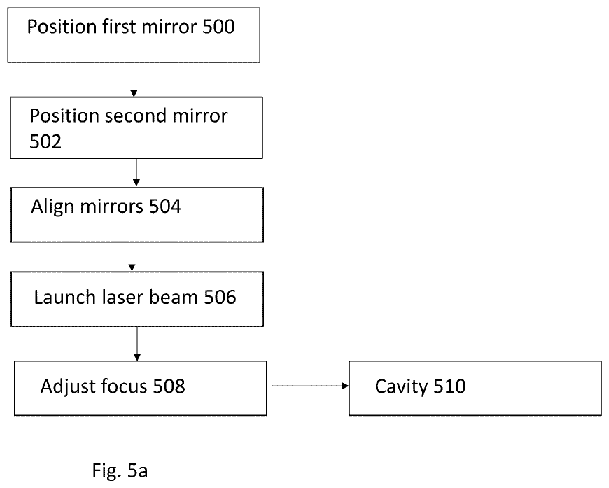

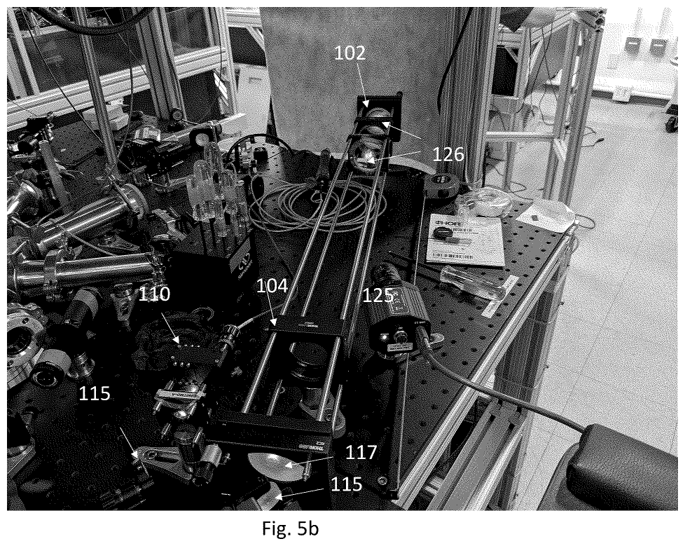

FIG. 5a is a flowchart illustrating a method of making an optical cavity.

Block 500 represents positioning a first concave mirror having a focal length.

Block 502 represents obtaining and positioning a second concave mirror having the focal length and an entry hole, at a separation distance from the first mirror that is slightly less than four times the focal length. The mirrors can be positioned on mirror mounts with adjustable angle and/or positioning for adjusting the separation.

As noted above, the radial position of the entry hole is typically smaller than ½ of the radius of the mirror but larger than a minimum distance required for at least 10 passes of the laser beam reflecting between the mirrors. The entry hole is sized such that the laser beam can be inputted through the entry hole without allowing substantial leakage (e.g., less than 30% leakage) of the circulating laser beam within the cavity.

Block 504 represents aligning the optical axis of the two mirrors facing each other, optionally allowing small misalignment. In some embodiments, if the mirrors are perfectly aligned and positioned, further adjustment of the mirror angles and separation of the mirrors is not necessary. Some misalignments between the two mirrors can be tolerated, without significantly impacting the performance, as described below in the experimental results section.

Block 506 represents positioning a laser beam to launch (e.g. using launching mirror 115) a collimated laser beam through the entry hole so that it reflects back from the first mirror to a position touching the entry hole and the subsequent reflected positions form a circle on the second mirror. Optomechanics (including a mirrors on a kinematic mount, fiber laser launcher, telescope for beam sizing, and/or focusing or diverging lenses) can be optionally used for guiding and changing the focus of the input beam.

Block 508 represents optionally adjusting the input laser focus so that (1) divergence of the laser beam creates the spot of the first reflection back on the second mirror having an area larger than the entry hole; and (2) the circulating laser beams within the cavity overlap with each other and form a uniform intensity distribution on the mirrors (similar to that illustrated in FIG. 4 (e)).

Detectors are not necessary as the user can use the laser spots on the mirror to judge the alignment and uniformity. However, optionally, a thin glass window with anti-reflection coatings 126 can be inserted into the cavity, which will scatter a small amount of light to show the laser pattern. A camera 125 can then be used for recording or intensity distribution measurement.

Curvature of the mirrors is flexible and can be chosen to suit any needs or constraints. Typically, higher curvature in combination with larger mirror size will yield higher performance.

In one embodiment, the cavity comprises a planar mirror in combination with the concave mirror comprising the entry hole. Such a configuration can be fabricated by assembling the cavity with two concave mirrors as described above, placing the planar mirror at the half way position in the cavity after alignment and then removing the first concave mirror.

Block 510 illustrates the end result, a cavity according to one or more embodiments

In one or more embodiments the cavity doesn't require complicated mechanism to align and doesn't require active stabilization using feedback to operate. However, a computer can be used to control alignment with feedback if desired in one or more embodiments.

### Example Experimental Characterization

FIG. 5b illustrates an cavity that was manufactured and tested. The cavity mirrors (CM508-200-E02, Thorlabs Inc) had 2-inch diameter with focal length of 200 mm and were separated by the cavity length of 792 mm (1% less than 4f=800 mm). The near mirror was modified with a 4 mm diameter hole drilled 5 mm away from the center of the mirror. The two cavity mirrors and the two launching mirrors were mounted on kinematic mounts (KC2, Thorlabs) while the laser light came out of a fiber launcher with an adjustable focus (C240TMD-A and PM460-HP, Thorlabs) close to the entry hole. The lasers used were single-mode ECDLs locked to a wavemeter.

(a) Measurement with Camera

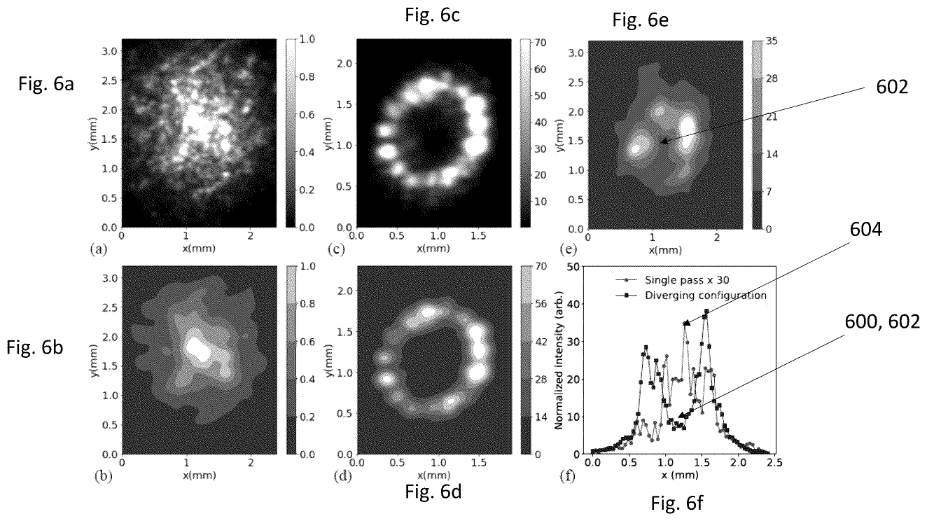

To quantify the performance of the cavity, an anti-reflection(AR)-coated window (WG12012-A, Thorlabs) was inserted into the cavity to image the beams while minimally perturbing the paths and intensities. The AR coated window could slide along the length of the cavity, to measure longitudinal intensity distribution. The signal was normalized by comparing it to the scattered light from a single pass of the laser beam expanded to a similar size. The results, shown in FIG. 4(e), 4(f), and FIG. 6 are in good agreement with the model and ray tracing simulations, both for the spot shape as well as for the total power. The shape of the spot patterns matches the model and simulation for all configurations that were tested.

FIG. 6(f) shows the uniformity of the intensity distribution is such that, when compared to the input Gaussian laser beam (diverged or focused to the same size), the minimum intensity of the cross section (in the direction perpendicular to the length of the cavity) is about 10 times that of the maximum of the intensity of the input laser beam. However, the uniformity can be tuned arbitrarily, e.g., so the minimum intensity of the cross-section at least 3 times that of maximum of the input laser beam. In other embodiments, the uniformity is such that, along the length of the cavity, all the cross sections of the overlapping laser beams have the intensity distribution substantially similar to (or approximating) that of a Gaussian beam—i.e., a minimum intensity at the center of the beam has intensity higher than 1/e\hat{ }2 of the maximum intensity of the input laser beam. The locations at which the intensity drops to 1/e\hat{ }2 of the maximum define the diameter of the Gaussian beam).

The measured intensity distribution agrees with the model and simulations to within 10%. While the intensity data measurements about 10% lower than those calculated in the simulations, the discrepancy can be mitigated using higher-grade optics and coatings. Despite these losses, the results show that, on average, the intensity is amplified by a factor of about 30 (for a 32 pass configuration) with a uniform intensity distribution.

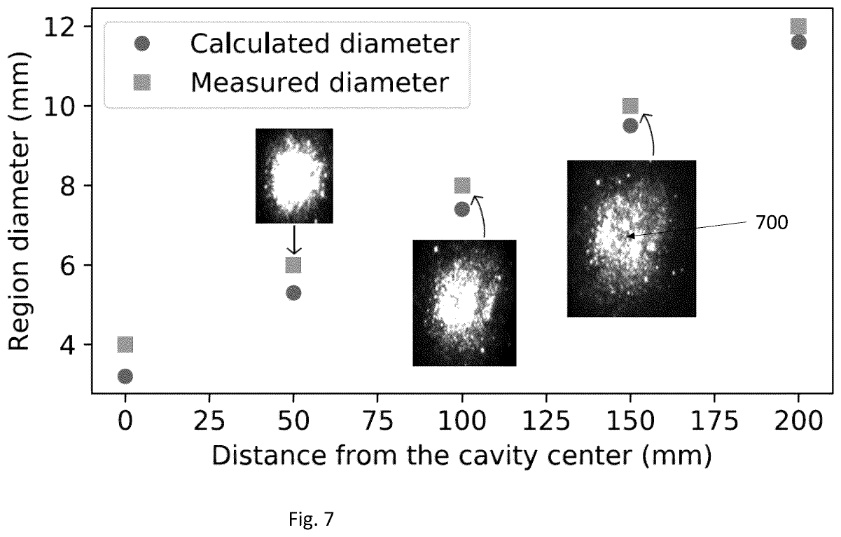

FIG. 7 shows measurement of the intensity at various positions along the cavity. While the intensity distribution is most concentrated, or has the highest intensity, at the center of the cavity, the intensity distribution is similar although stretched in size at other cross sections along the length of the cavity. FIG. 7 further demonstrates that the diameter D of the intensity distribution increases approximately linearly with distance along the cavity axis from a center of the cavity and/or is given by:

$$D ( z ) \approx 4 {x}_{0} ( a + 2 z \frac{1 - a}{d} )$$

where xₒ is the radial position of the entry hole and a=π−cos⁻¹(1−d/2 f), the angle between consecutive laser spots on the same mirror.

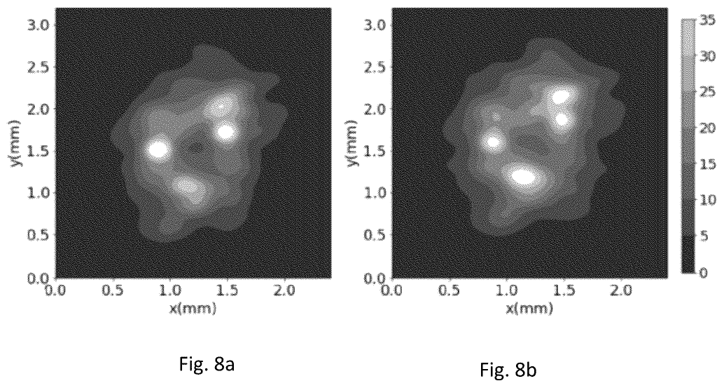

Chromatic aberration or other wavelength dependent phenomena were tested using different lasers launched using the same fiber and aspheric lens. FIG. 8 shows the intensity distributions using a 650 nm wavelength laser and a 577 nm wavelength laser. Thus, the cavity can be operated by combining multiple laser beams with different frequencies, or combination into a single beam. For example, the beam can be launched from a single fiber using a combination of dichroic mirrors, beam splitters, and acousto-optical modulators [28], or using a fiber cluster [29].

### (b) Measurement in an Application

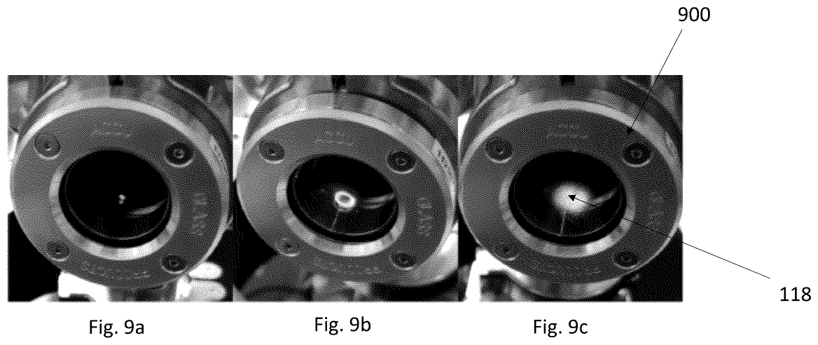

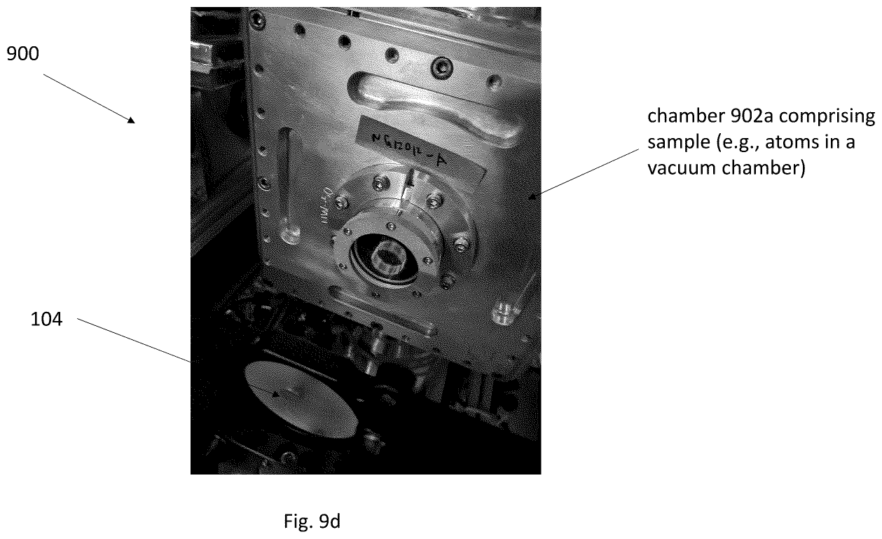

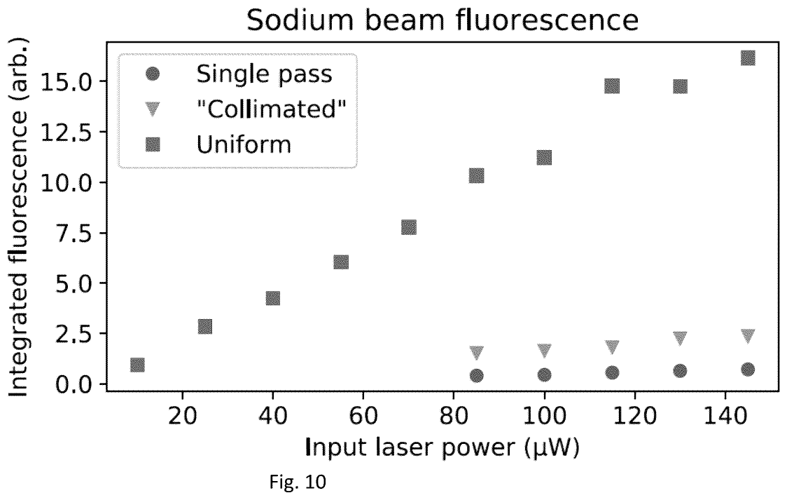

The cavity was set up in a cryogenic atomic and molecular beam source and the fluorescence of the sodium beams was measured using a laser on the D1 transition. The results were compared from three configurations: 1) a single pass, as shown in FIG. 9(a); 2) the Herriott cell multi-pass in the “collimated” configuration, as shown in FIG. 9(b); and 3) a diverging configuration optimized for even intensity distribution, as shown in FIG. 9(c). FIG. 10 shows that using the diverging Herriott cell as a nonresonant power buildup cavity results in an increase in the atomic fluorescence by a factor of around 25. The reduction as compared to the factor of 30 (expected from the intensity increase) results mostly from the saturation of the atomic transition, geometry change of the fluorescing atom cloud, and the power loss on the vacuum chamber windows. However, the data shows a more than one order of magnitude improvement in the fluorescence signal using the cavity.

### Robustness to Misalignment

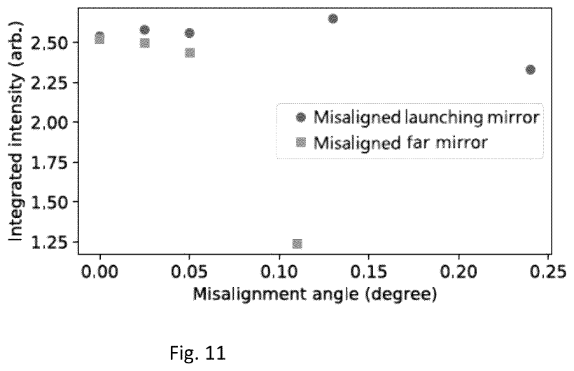

The robustness of the cavity against misalignment was characterized by measuring how the scattered light on the AR-coated window changes depending on the misalignment angles of the cavity mirrors and the launching mirror. FIG. 11 shows that total power within the cavity started to decrease when the launching mirror was misaligned by more than 0.24°, whereas for misalignments of either of the cavity mirrors, the power loss starts to become significant for misalignments above 0.05 degrees. Thus, misalignment of the cavity mirrors had a significantly larger effect than misalignment of the launching mirror (because changes in the cavity condition and deviations accumulate as the laser beam propagates back and forth in the cavity). However, both misalignment limits are larger than the typical drifts commonly encountered (for example, the 0.24° misalignment required a half turn of the steering knob on the launching mirror). Thus, the measurements show that the cavity is very robust against a small misalignment that might be caused by thermal drifts, vibrations, or even accidental bumps. A configuration with a more uniform intensity distribution would be even less prone to misalignment because, in such a configuration, the laser beams are expanded to be significantly larger than the entry hole when they arrive at the mirrors. As such, leakage out of the mirror due to misalignment has a much reduced impact on power loss.

This robustness against misalignment is also advantageous for applications sensitive to interference where negative effects are mitigated by modulating the cavity length. For example, MOTs often use lasers with long coherence lengths where interference in the retro-reflected beams results in nonuniform and varying intensity distributions. A typical solution is to add a small oscillating displacement to one of the mirrors [30], which averages over the interference pattern. The robustness of the cavity described herein enables implementation of such a solution if needed.

### Example Applications

A function of the cavity is to increase the total laser power by overlapping the multi-pass laser beams and maintain a relatively uniform intensity distribution while increasing the total laser power (as opposed to, for example, merely sharply focusing the laser beam to increase the intensity). Unlike conventional cavities or multi-pass setups, the optical cavity described herein can provide this functionality while accommodating multiple laser beams of different wavelengths and achieving similar performance for all of the laser beams.

Increased laser power is beneficial for a variety of applications and the cavity can be applied to any situation where a high power laser beam is required and the laser beam would not be significantly absorbed or reflected by the interaction region.

In one application, the cavity can be used to amplify laser intensity for repumping molecules from dark states in a magneto-optical trap, where multiple repump lasers are needed in a confined region of few-mm in diameter.

FIGS. 9-10 illustrate another application, wherein the cavity has been used to increase the signal in laser induced fluorescence spectroscopy. FIG. 9c shows how the second cavity mirror with the entry hole can be placed outside the application chamber containing the sample, with the first cavity mirror placed inside the application chamber or on the opposite side of the application chamber so that the uniform intensity distribution interacts with the sample within the application chamber.

In another embodiment, the cavity of FIG. 1c could be modified to include a sample holder 120 for mounting a sample comprising a material 122 so as to interact the material with the intensity distribution 118. The cavity can be used to build up the power of the electromagnetic radiation interacting with the material, especially when the material does not substantially reflect or absorb the electromagnetic radiation. Yet further applications require implementation of the cavity using two or more lasers. The cavity has been used for exciting Rydberg atoms through a two photon process, where high intensity is needed [31]. The cavity can be used to build up power of cheaper diode lasers to obtain the same or better power achievable with a more expensive laser. Yet further applications implement flexible positioning and/or shape of the cavity. For example, a planar mirror can be placed in the middle to fabricate an “L” shaped cavity, or the concave mirror without the entry hole can be replaced with a planar mirror (lowering the cavity length by half and rendering the cavity more compact with some small loss in performance).

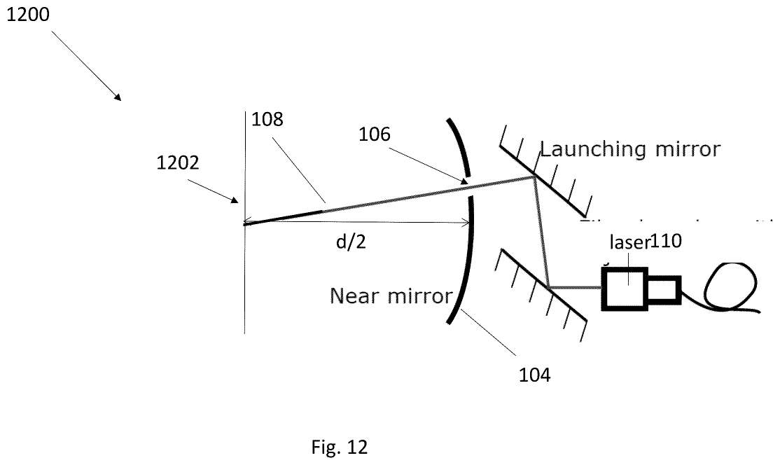

FIG. 12 illustrates an embodiment with a planar cavity 1200 comprises a first planar mirror 1204; a second concave mirror 104 comprising a focal length and having an entry hole 106 for receiving a laser beam into the cavity, wherein the second mirror and the first mirror face each other and are separated by a distance of slightly smaller than two times the focal length. The constraints for the position of the entry hole are the same for the embodiments with two concave mirrors, i.e., the radial distance of the entry hole from a center of the second concave mirror is smaller than ½ of the radius of the mirror; and larger than a minimum distance required for at least 10 passes of the laser beam reflecting between the mirrors. As with the double concave mirror embodiment, the laser beam is a near collimated gaussian beam having its focus adjusted so that all the passes of the laser beam overlap to buildup power of the electromagnetic radiation in a uniform intensity distribution in cross-sections perpendicular to a length of the cavity. Such a configuration can be fabricated by assembling the cavity with two concave mirrors, placing the planar mirror at the half way position in the cavity after alignment (as discussed herein) and then removing the first concave mirror.

Such configurations may be useful for integrated systems where two or more overlapping high intensity lasers are required, such as (but not limited to) for pumping light for UV sources, sum-frequency generation (SFG), producing ions or Rydberg atoms, probing in multiphoton spectroscopy, or an integrated trap system for atoms or molecules.

In yet a further application, the power build up can be configured to help enhance initiation of a reaction, e.g., such as a chemical or nuclear reaction. For example, a laser fusion reactor fuel (comprising deuterium, tritium, boron, or hydrogen) can be placed within the cavity so that the uniform intensity distribution and power build up initiates a fusion reaction of the fuel.

### Advantages and Improvements

As compared to a conventional actively-stabilized resonant cavity (where the cavity length is in resonance with the laser wavelength to boost intensity) the method and cavity according to embodiments described herein has the following advantages:
1. It can accommodate multiple lasers of different wavelengths (for resonant cavity, adding one or two more lasers requires precise engineering and will significantly compromise performance).
2. It is much easier to set up and tune. Resonant cavities require precise engineering and fine tuning with special equipment, whereas the non-resonant cavity described herein can be set up in a few minutes and the cavity length can be measured with the precision of a ruler. Because the cross section patterns of laser beams inside the cavity are the same as the ones on mirrors, the cavity can be optimized and tuned merely by observing the scattered light on the mirrors.
3. It is highly robust against any perturbations (such as, but not limited to, air turbulence or even accidental bumps) and does not require active stabilization. Resonant cavities, on the other hand, require precise alignment and constant servo feedback to maintain the exact cavity length, and typically the whole cavity has to be inside the vacuum chamber to reduce any perturbation. The non-resonant cavity described herein can be placed either inside or outside a vacuum chamber.

As compared to a method for building up laser power using a multi-pass reflection between two or more planar mirrors, the cavity described herein can achieve close to two orders of magnitude of intensity buildup, with a uniformity similar to (or better than) that of a Gaussian beam. The multi-pass scheme, on the other hand, is generally used for extended interaction regions and is not capable of overlapping all the passes to build up intensity. Moreover, any intensity build up is significantly lower (less than an order of magnitude) with poor uniformity.

### Illustrative Embodiments

Illustrative embodiments include, but are not limited to, the following (referring also to FIGS. 1-12).
1. A (e.g. optical) cavity 100 for electromagnetic radiation 120, comprising:
a first concave mirror 102 having a focal length;
a second concave mirror 104 comprising the focal length and having an entry hole 106 for receiving a laser beam 108 into the cavity, wherein:
the second mirror and the first mirror face each other and are separated by a distance d of (e.g., slightly) smaller than four times the focal length so that the cavity is in a near concentric configuration;
a radial distance R of the entry hole from a center of the second concave mirror is:
   smaller than ½ of the radius of the mirror; and
   larger than a minimum distance required for at least 10 passes of the laser beam reflecting between the mirrors; and
the laser beam is a near collimated gaussian beam having its focus adjusted so that all the passes 400 of the laser beam 108 overlap 402 to buildup power of the electromagnetic radiation 120 in a uniform intensity distribution 118 in cross-sections 700 perpendicular to a length L of the cavity.
2 The cavity of embodiment 1, wherein the input laser beam is angled and the mirrors are aligned such that the passes:
are arranged a circular pattern 200 around a longitudinal axis 208 of the cavity; and
form consecutive reflection spots NM1, FM1 on opposite sides (quadrants 204, 206 of the polar graph plot) of the mirrors so that the passes are near a center 210, 408 of the cavity at a middle 114 of the cavity.
3. The cavity of embodiment 1 or 2, wherein the all the beams substantially overlap with each other such that a total power of the passes 116 in the cavity is n times the power of the inputted laser beam, where n is the number of passes of the laser beam in the cavity.
4a. The optical cavity of any of the embodiments 1-3, wherein along the length of the cavity, all the cross sections of the overlapping laser beams 402 have the intensity distribution 118, in a plane perpendicular to the length L, such that a minimum intensity 600 at a center 602 of the intensity distribution is higher than 1/e\hat{ }2 (or 1/e²) of a maximum intensity 604 of the input laser beam (in a single pass diverged or focused to the same size as the intensity distribution 118, having its maximum intensity multiplied by 30 or 10, and measured at the same location in the cavity as the uniform intensity distribution).
4b. The optical cavity of any of the embodiments 1-3, wherein along the length of the cavity, all the cross sections of the overlapping laser beams 402 have the intensity distribution 118, in a plane perpendicular to the length L, such that a minimum intensity 600 at a center 602 of the intensity distribution is higher than 1/ê2 (or 1/e²) of a maximum intensity 604 of the input laser beam 119 (in a single pass diverged or focused to the same size as the intensity distribution 118, having its maximum intensity multiplied by an appropriate scaling factor taking into the account the number of passes 450 of the laser beam and cavity loses, and measured at the same location in the cavity as the uniform intensity distribution 118).
4c. The optical cavity of any of the embodiments 1-3, wherein along the length of the cavity, all the cross sections of the overlapping laser beams 402 have the intensity distribution 118, in a plane perpendicular to the length L, such that a minimum intensity 600 at a center 602 of the intensity distribution is higher than 1/e\hat{ }2 (or 1/e²) of a maximum intensity 604 of the input laser beam 119 (in a single pass 116 diverged or focused to the same size as the intensity distribution 118, having its maximum intensity multiplied by the number of passes 450 of the laser beam, and measured at the same location in the cavity as the uniform intensity distribution 118).
4d. The optical cavity of any of the embodiments 1-3, wherein along the length of the cavity, all the cross sections of the overlapping laser beams 402 form the intensity distribution 118, in a plane perpendicular to the length L, that is more uniformly spread out with smaller variation of the intensity from a mean/average value (e.g., at the full width at half maximum FWHM or 1/e² times maximum) of the intensity, as compared to the variation of the intensity of the input beam 119 in the first pass.
5. The cavity of any of the embodiments 1-4, wherein a diameter D of the intensity distribution increases linearly with distance along the cavity axis L from a center of the cavity and/or is given by:

$$D ( z ) \approx 4 {x}_{0} ( a + 2 z \frac{1 - a}{d} )$$

where xₒ is the radial position of the entry hole and a=π−cos−1(1−d/2 f), the angle between consecutive laser spots on the same mirror.
6. The cavity of any of the embodiments 1-5, wherein:
the entry hole is sized (e.g., has a diameter) such that the laser beam can be inputted through the entry hole without allowing substantial leakage of the circulating laser beam within the cavity; and
the divergence of the laser beam is such that the laser spot of the first reflection back on the second mirror has an area larger than the entry hole.
7. The optical cavity of any of the embodiments 1-6, wherein the radial distance R is between ½ of the entry hole's radius and ½ of the radius of the mirror.
8. The optical cavity of any of the embodiments 1-7, wherein the mirrors are separated by the distance d that is less than 15% smaller or less than 1% smaller than 4F (where F is the focal distance).
9 The optical cavity of any of the embodiments claim 1-8, wherein the laser beam comprises one or more beams comprising different wavelengths.
10. An apparatus 900 comprising the cavity 100 of any of the embodiments 1-9 to build up the power of the electromagnetic radiation 120 for interacting with material 122, wherein the material does not substantially reflect or absorb the electromagnetic radiation.
11. The apparatus of embodiment 10, comprising a trap (e.g., atom or ion or molecular trap) wherein the material comprises ions, atoms, molecules or macroscopic particles such as silica microspheres. In one or more examples, the laser beams/uniform intensity 118 in the cavity would be different from the trapping electromagnetic fields used for trapping the atoms, ions, or molecules, i.e., the cavity intensity distribution would be used for an interaction or manipulation separate from the trapping.
12 The apparatus of embodiment 10 for manipulating quantum states, wherein the build up of power is configured for coherently manipulating the quantum states of the material.
13. The apparatus of embodiment 10, wherein the power build is configured to enhance initiation of a reaction of the material, e.g., such as a chemical or nuclear reaction such as a fusion reaction.
14. A method of making (or providing instructions for making) an optical cavity (e.g., of any of the embodiments 1-13), comprising (or optionally providing the following instructions), e.g. as illustrated and described in FIG. 5a:
Positioning 500 a first concave mirror having a focal length;
positioning 502 a second concave mirror having the focal length and an entry hole, at a distance from the first mirror that is slightly less than four times the focal length;
aligning 504 the optical axis of the two mirrors facing each other, optionally allowing for a misalignment;
launching 506 a near-collimated laser beam through the entry hole so that the laser beam reflects back from the first mirror to a position just touching the entry hole and the subsequent reflected positions of the laser beam form a circle on the mirror; and
adjusting 508 a focus of the laser beam so that the circulating laser beams within the cavity overlap with each other and form a uniform intensity distribution on the mirrors and on cross sections along the length of the cavity.
15. A kit for making an optical cavity (e.g., of any of the embodiments 1-13), comprising:
a first concave mirror 102 having a focal length;
a second concave mirror 104 comprising the focal length and having an entry hole 106 for receiving a laser beam, wherein:
a radial distance R of the entry hole 106 from a center of the second concave mirror is smaller than ½ of the radius of the mirror; and
   larger than a minimum distance required for at least 10 passes of the laser beam 108 between the mirrors when the mirrors are separated in the near concentric configuration;
the entry hole is sized such that the laser beam can fit within the entry hole without allowing substantial leakage of the circulating laser beam within the cavity; and
a laser 110 and focusing element configured for outputting the gaussian laser beam having its focus adjusted so that all the passes of the laser beam in the cavity overlap to buildup power of the electromagnetic radiation in a uniform intensity distribution across cross-sections perpendicular to the length of the cavity when the cavity is assembled.
16. The kit of embodiment 15, further comprising instructions for assembling the cavity so that all the passes of the laser beam in the cavity overlap to buildup power of the electromagnetic radiation in a uniform intensity distribution across cross-sections perpendicular to the length of the cavity when the cavity is assembled.
17. A cavity 100, comprising:
a first concave mirror 102 having a focal length;
a second concave mirror 104 comprising the focal length and having an entry hole 106 for receiving a laser beam 108, wherein the cavity is fabricated using a process comprising selecting:
a separation d of the cavity mirrors in a near-concentric configuration;
a position of the entry hole; and
a divergence of the laser beam;
wherein all the passes of the laser beam in the cavity overlap to buildup power of the electromagnetic radiation in a uniform intensity distribution across cross-sections perpendicular to a length L of the cavity 100.
18. The cavity of embodiment 17 comprising any of the embodiments 2-13 and/or manufactured using the method of embodiment 14.
19. A cavity 1200 for electromagnetic radiation 108, comprising:
a first planar mirror 1202;
a second concave mirror 104 comprising the focal length and having an entry hole 106 for receiving a laser beam into the cavity, wherein:
the second mirror and the first mirror face each other and are separated by a distance d/2 of slightly smaller than two times the focal length;
a radial distance R of the entry hole from a center of the second concave mirror is: smaller than ½ of the radius of the mirror; and
   larger than a minimum distance required for at least 10 passes of the laser beam reflecting between the mirrors; and
the laser beam 108 is a near collimated gaussian beam having its focus adjusted so that all the passes of the laser beam overlap to buildup power of the electromagnetic radiation in a uniform intensity distribution in cross-sections perpendicular to a length of the cavity.
20 The cavity of embodiment 19 according to any of the embodiments 2-13 and/or manufactured using the method of embodiment 14.
21 The cavity of any of the embodiments 1-20, wherein the electromagnetic radiation comprises ultraviolet, visible, or infrared electromagnetic radiation, or radiation having longer wavelengths, or any wavelength.
22. The cavity of any of the embodiments 1-21, wherein the laser comprises one or more lasers (e.g., comprising a laser diode) comprising a blue laser emitting blue light, a red laser emitting red light, and/or a green laser emitting green light, or any combination thereof, or any laser.
23 The cavity of any of the embodiments 1-21 comprising a light emitting diode or other source of the electromagnetic radiation.

### REFERENCES

The following references are incorporated by reference herein.
1 L. D. Carr, D. DeMille, R. V. Krems, and J. Ye, “Cold and ultracold molecules: science, technology and applications,” New J. Phys. 11, 055049 (2009).
2 D. DeMille, J. M. Doyle, and A. O. Sushkov, “Probing the frontiers of particle physics with tabletop-scale experiments,” Science 357, 990994 (2017).
3. M. Safronova, D. Budker, D. DeMille, D. F. J. Kimball, A. Derevianko, and C. W. Clark, “Search for new physics with atoms and molecules,” Rev. Mod. Phys. 90, 025008 (2018).
4. N. R. Hutzler, “Polyatomic molecules as quantum sensors for fundamental physics,” Quantum Sci. Technol. 5, 044011 (2020).
5. D. DeMille, “Quantum computation with trapped polar molecules,” Phys. Rev. Lett. 88, 067901 (2002).
6. R. Barnett, D. Petrov, M. Lukin, and E. Demler, “Quantum magnetism with multicomponent dipolar molecules in an optical lattice,” Phys. Rev. Lett. 96, 190401 (2006).
7. A. V. Gorshkov, S. R. Manmana, G. Chen, J. Ye, E. Demler, M. D. Lukin, and A. M. Rey, “Tunable superfluidity and quantum magnetism with ultracold polar molecules,” Phys. Rev. Lett. 107, 115301 (2011).
8 J. L. Bohn, A. M. Rey, and J. Ye, “Cold molecules: Progress in quantum engineering of chemistry and quantum matter,” Science 357, 1002-1010 (2017).
9. J. A. Blackmore, L. Caldwell, P. D. Gregory, E. M. Bridge, R. Sawant, J. Aldegunde, J. Mur-Petit, D. Jaksch, J. M. Hutson, B. E. Sauer, M. R. Tarbutt, and S. L. Cornish, “Ultracold molecules for quantum simulation: rotational coherences in CaF and RbCs,” Quantum Sci. Technol. 4, 014010 (2018).
10. J. P. Ríos, An Introduction to Cold and Ultracold Chemistry (Springer International Publishing, 2020).
11. Y. Liu and K.-K. Ni, “Bimolecular chemistry in the ultracold regime,” Annu. Rev. Phys. Chem. 73, 73-96 (2022).
12. H. J. Metcalf and P. van der Straten, Laser Cooling and Trapping (Springer-Verlag, 1999).
13. N. Fitch and M. Tarbutt, “Laser-cooled molecules,” Adv. At. Mol. Opt. Phys. 70, 157-262 (2021).
14. I. Kozyryev, L. Baum, K. Matsuda, B. L. Augenbraun, L. Anderegg, A. P. Sedlack, and J. M. Doyle, “Sisyphus laser cooling of a polyatomic molecule,” Phys. Rev. Lett. 118, 173201 (2017).
15. D. Mitra, N. B. Vilas, C. Hallas, L. Anderegg, B. L. Augenbraun, L. Baum, C. Miller, S. Raval, and J. M. Doyle, “Direct laser cooling of a symmetric top molecule,” Science 369, 1366-1369 (2020).
16. N. B. Vilas, C. Hallas, L. Anderegg, P. Robichaud, A. Winnicki, D. Mitra, and J. M. Doyle, “Magneto-optical trapping and sub-Doppler cooling of a polyatomic molecule,” Nature 606, 70-74 (2022).
17. B. L. Augenbraun, J. M. Doyle, T. Zelevinsky, and I. Kozyryev, “Molecular asymmetry and optical cycling: laser cooling asymmetric top molecules,” Phys. Rev. X 10, 031022 (2020).
18. D. Mitra, Z. D. Lasner, G.-Z. Zhu, C. E. Dickerson, B. L. Augenbraun, A. D. Bailey, A. N. Alexandrova, W. C. Campbell, J. R. Caram, E. R. Hudson, and J. M. Doyle, “Pathway toward optical cycling and laser cooling of functionalized arenes,” J. Phys. Chem. Lett. 13, 7029-7035 (2022).
19. J. A. Barnes, T. E. Gough, and M. Stoer, “Laser power build-up cavity for high-resolution laser spectroscopy,” Rev. Sci. Instrum. 70, 35153518 (1999).
20 D. A. King and R. J. Pittaro, “Simple diode pumping of a power-buildup cavity,” Opt. Lett. 23, 774 (1998).
21. S. Ohara, S. Yamaguchi, M. Endo, K. Nanri, and T. Fujioka, “Performance characteristics of power build-up cavity for Raman spectroscopic measurement,” Opt. Rev. 10, 342-345 (2003).
22 E. S. Shuman, J. F. Barry, and D. DeMille, “Laser cooling of a diatomic molecule,” Nature 467, 820-823 (2010).
23. D. R. Herriott and H. J. Schulte, “Folded optical delay lines,” Appl. Opt. 4, 883 (1965).
24. C. G. Tarsitano and C. R. Webster, “Multilaser Herriott cell for planetary tunable laser spectrometers,” Appl. Opt. 46, 6923 (2007).
25. C. Robert, “Simple, stable, and compact multiple-reflection optical cell for very long optical paths,” Appl. Opt. 46, 5408 (2007).
26 B. E. Saleh and M. C. Teich, Fundamentals of Photonics (Wiley, 2019).
27 N. R. Hutzler, H.-I. Lu, and J. M. Doyle, “The buffer gas beam: An intense, cold, and slow source for atoms and molecules,” Chem. Rev. 112, 4803-4827 (2012).
28. J. F. Barry, “Laser cooling and slowing of a diatomic molecule,” Ph.D. thesis (Yale University, 2013).
29 H. J. Williams, S. Truppe, M. Hambach, L. Caldwell, N. J. Fitch, E. A. Hinds, B. E. Sauer, and M. R. Tarbutt, “Characteristics of a magnetooptical trap of molecules,” New J. Phys. 19, 113035 (2017).
30. L. R. Liu, “Building single molecules-reactions, collisions, and spectroscopy of two atoms,” Ph.D. thesis (Harvard University, 2019).
31. doi: 10.1088/1742-6596/653/1/012123.
32 Further information on one or more embodiments of the present invention can be found in “Nonresonant cavity for multipass laser intensity buildup” by Yi Zeng* AND Nicholas R. Hutzler Vol. 62, No. 14/10 May 2023/Applied Optics, page 3574.

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. A cavity for electromagnetic radiation, comprising:
a first concave mirror having a focal length;
a second concave mirror comprising the focal length and having an entry hole for receiving a laser beam into the cavity, wherein:
the second mirror and the first mirror face each other and are separated by a distance of slightly smaller than four times the focal length so that the cavity is in a near concentric configuration;
a radial distance of the entry hole from a center of the second concave mirror is:
smaller than ½ of the radius of the mirror; and
larger than a minimum distance required for at least 10 passes of the laser beam reflecting between the mirrors; and
the laser beam is a near collimated gaussian beam having its focus adjusted so that all the passes of the laser beam overlap to buildup power of the electromagnetic radiation in a uniform intensity distribution in cross-sections perpendicular to a length of the cavity.

2. The cavity of claim 1, wherein the input laser beam is angled and the mirrors are aligned such that the passes:
are arranged a circular pattern around a longitudinal axis of the cavity; and
form consecutive reflection spots on opposite sides of the mirrors so that the passes are near a center of the cavity at a middle of the cavity.

3. The cavity of claim 1, wherein the all the beams substantially overlap with each other such that a total power of the passes in the cavity is n times the power of the inputted laser beam, where n is the number of passes of the laser beam in the cavity.

4. The cavity of claim 1, wherein along the length of the cavity, all the cross sections of the overlapping laser beams have the intensity distribution, in a plane perpendicular to the length, such that a minimum intensity at a center of the intensity distribution is higher than 1/e\hat{ }2 of a maximum intensity of the input laser beam diverged or focused to the same size.

5. The cavity of claim 4, wherein a diameter D of the intensity distribution increases linearly with distance along the cavity axis from a center of the cavity and/or is given by:
$$D ( z ) \approx 4 {x}_{0} ( a + 2 z \frac{1 - a}{d} )$$
where xo is the radial position of the entry hole and a=π−cos−1(1−d/2 f), the angle between consecutive laser spots on the same mirror.

6. The cavity of claim 1, wherein:
the entry hole is sized such that the laser beam can be inputted through the entry hole without allowing substantial leakage of the circulating laser beam within the cavity; and
the divergence of the laser beam is such that the laser spot of the first reflection back on the second mirror has an area larger than the entry hole.

7. The cavity of claim 1, wherein the radial distance is between ½ of the entry hole radius and ½ of the radius of the mirror.

8. The cavity of claim 1, wherein the mirrors are separated by the distance that is less than 15% smaller or less than 1% smaller than 4F (where F is the focal distance).

9. The cavity of claim 1, wherein the laser beam comprises one or more beams comprising different wavelengths.

10. An apparatus comprising the cavity of claim 1 to build up the power of the electromagnetic radiation for interacting with material, wherein the material does not substantially reflect or absorb the electromagnetic radiation.

11. The apparatus of claim 10, comprising a trap wherein the material comprises ions, atoms, molecules or macroscopic particles such as silica microspheres.

12. The apparatus of claim 10 for manipulating quantum states, wherein the build up of power is configured for coherently manipulating the quantum states of the material.

13. The apparatus of embodiment 10, wherein the build up is configured to enhance initiation of a reaction of the material.

14. The apparatus of claim 13, wherein the reaction is a fusion reaction.

15. The cavity of claim 1, wherein along the length of the cavity, all the cross sections of the overlapping laser beams form the intensity distribution 118, in a plane perpendicular to the length, that is more uniformly spread out with smaller variation of the intensity from a mean value of the intensity, as compared to the variation of the intensity of the input beam in a first pass.

16. A method of making an cavity, comprising:
positioning a first concave mirror having a focal length;
positioning a second concave mirror having the focal length and an entry hole, at a distance from the first mirror that is slightly less than four times the focal length;
aligning the optical axis of the two mirrors facing each other, optionally allowing for a misalignment;
launching a near-collimated laser beam through the entry hole so that the laser beam reflects back from the first mirror to a position just touching the entry hole and the subsequent reflected positions of the laser beam form a circle on the mirror; and
adjusting a focus of the laser beam so that the circulating laser beams within the cavity overlap with each other and form a uniform intensity distribution on the mirrors and on cross sections along the length of the cavity.

17. The method of claim 16, further comprising providing instructions for the positioning, aligning, the launching, and the adjusting.

18. The method of claim 17, further comprising using the cavity to build up the power of the electromagnetic radiation for interacting with material, wherein the material does not substantially reflect or absorb the electromagnetic radiation.

19. A kit for making an optical cavity, comprising:
a first concave mirror having a focal length;
a second concave mirror comprising the focal length and having an entry hole for receiving a laser beam, wherein:
a radial distance of the entry hole from a center of the second concave mirror is smaller than ½ of the radius of the mirror; and
larger than a minimum distance required for at least 10 passes of the laser beam between the mirrors when the mirrors are separated in the near concentric configuration;
the entry hole is sized such that the laser beam can fit within the entry hole without allowing substantial leakage of the circulating laser beam within the cavity; and
a laser and focusing element configured for outputting the gaussian laser beam having its focus adjusted so that all the passes of the laser beam in the cavity overlap to buildup power of the electromagnetic radiation in a uniform intensity distribution across cross-sections perpendicular to the length of the cavity when the cavity is assembled.

20. The kit of claim 19, further comprising instructions for assembling the cavity so that all the passes of the laser beam in the cavity overlap to buildup power of the electromagnetic radiation in a uniform intensity distribution across cross-sections perpendicular to the length of the cavity when the cavity is assembled.
